(19) United States
(12) Patent Application Publication
(10) Pub. No.: US 2016/0239683 A1
(43) Pub. Date: Aug. 18, 2016

(54) System and method for securely storing files

(71) Applicants: Inder-Jeet Singh Gujral, Wenham, MA (US); Anand Shah, Pune (IN)

(72) Inventors: Inder-Jeet Singh Gujral, Wenham, MA (US); Anand Shah, Pune (IN)

(21) Appl. No.: 15/137,040

(22) Filed: Apr. 25, 2016

Related U.S. Application Data
(63) Continuation-in-part of application No. 13/832,187, filed on Mar. 15, 2013.

(51) Int. Cl. G06F 21/62

(52) U.S. Cl. CPC G06F 21/6272; G06F 2221/2107

(57) ABSTRACT

A method for securely storing a file includes receiving, by a computing device, an instruction to store a file. The method includes dividing, by the computing device, the file into a plurality of fragments having randomly selected sizes. The method includes storing, by the computing device, the plurality of fragments in a plurality of fragment stores.

### TECHNICAL FIELD

This invention relates to secure electronic storage. More particularly, the present invention relates to methods and systems for securely storing files.

### BACKGROUND ART

In recent years, people have become increasingly dependent on electronically stored data files. In addition to confidential notes, writings, and work products that are frequently produced on computers, people increasingly keep electronic copies of such crucial documents as deeds to houses and cars, home and life insurance policies, tax documents, medical records, and bills. Electronic storage in digital media allows users to store large volumes of information indefinitely owing to the ability of noise-proof digital protocols to make essentially perfect copies of data files. Electronic storage also makes it possible to access the data remotely, particularly where the data is stored according to a protocol, such as cloud computing, calculated for ease of access. However, electronic file storage is not without drawbacks. Security is a particular problem, as the very ease of communication that makes the electronically stored documents readily accessible also provides avenues for hackers to swipe information. Although many security techniques exist to protect against cybercriminals, no method of security is perfect, and the hackers are always devising new techniques for cracking existing methods. The battle against unauthorized access of data files is thus perennial, calling for ever more sophisticated tactics to frustrate intruders.

In addition to the costs of actual intrusions, the public perception of vulnerability can be costly in its own right. For instance, cloud storage has recently become a cost-effective and efficient way to store large quantities of data. Unfortunately, a corporate officer responsible for the security of a firm's data may be reluctant to store that data on the cloud, because to do so is to relinquish direct control over that data's security; this may be the case even though the cloud storage facility may have far more sophisticated security than that available to the firm for local use. As a result, the firm will incur far greater expense storing data locally, often with inferior security and at greater risk of accidental data loss.

In view of the above, there is a need for an efficient way to enhance the security of electronic file storage.

### SUMMARY OF THE EMBODIMENTS

In one aspect, a method for securely storing a file includes receiving, by a computing device, an instruction to store a file. The method includes dividing, by the computing device, the file into a plurality of fragments having randomly selected sizes. The method includes storing, by the computing device, the plurality of fragments in a plurality of fragment stores.

In a related embodiment, the method includes representing the file as a sequence of regularly sized data units and determining a size of the file equal to a total number of the regularly sized data units comprising the file. In another embodiment, dividing further includes generating a first random number less than the size of the file and producing a first fragment by extracting from the file a quantity of the data units of the file equal to the first random number. An additional embodiment includes generating a second random number less than the size of the file minus the first random number and producing a second fragment by extracting a quantity of remaining data units of the file equal to the second random number. Another embodiment includes generating a plurality of random numbers having a sum less than the size of the file and, for each number of the plurality of random numbers, extracting from the data units that have not yet been extracted from the file a quantity equal to the number.

In another embodiment, storing also involves randomly selecting, by the computing device, a first fragment store from a plurality of fragment stores, and storing, by the computing device, a first fragment of the plurality of fragments in the first fragment store. Another embodiment includes randomly selecting, by the computing device, a second fragment store from the plurality of fragment stores, and storing, by the computing device, a second fragment of the plurality of fragments in the second fragment store. In a further embodiment, storing also includes storing a first fragment of the plurality of fragments in a fragment store in a first data storage facility and a second fragment of the plurality of fragments in a second data storage facility, wherein the second data storage facility is distinct from the first data storage facility.

An additional embodiment further includes generating a unique file identifier associated with the file and associating the file identifier with each of the plurality of fragments. Yet another embodiment also includes generating a plurality of fragment identifiers, each of the plurality of fragment identifiers corresponding to one and only one fragment of the plurality of fragments, and associating each fragment identifier of the plurality with the corresponding fragment of the plurality of fragments. Another embodiment still involves encrypting the file.

Another related embodiment includes receiving, by the computing device, a request for the file, retrieving, by the computing device, the plurality of fragments from the plurality of fragment stores, and assembling the plurality of fragments to produce the file. In an additional embodiment, each fragment of the plurality of fragments is associated with a file identifier corresponding to the file, and retrieving further includes retrieving a plurality of fragments associated with the file identifier. In a further embodiment, each fragment of the plurality of fragments is associated with a fragment identifier, and assembling also involves determining an order of assembly based on fragment identifiers and assembling the fragments in the determined order of assembly. A further embodiment still involves representing the file as an ordered sequence of regularly sized data units, determining a size of the file equal to a total number of the regularly sized data units comprising the file, determining that the plurality of retrieved fragments contains a number of data units equal to the size of the file, and determining that fragments representing the entire file have been retrieved. Yet another embodiment also includes decrypting the file.

In another aspect, a system for securely storing files includes a plurality of fragment stores and a computing device configured to receive an instruction to store a file, divide the file into a plurality of fragments having randomly selected sizes, and to store the plurality of fragments in the plurality of fragment stores.

These and other features of the present invention will be presented in more detail in the following detailed description of the invention and the associated figures.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of a computing device as described herein;

FIG. 1B is a schematic diagram of a network-based platform, as disclosed herein;

FIG. 2 is a block diagram of an embodiment of the disclosed system;

FIG. 3 is a flow diagram illustrating one embodiment of the disclosed methods;

FIG. 4 is a flow diagram illustrating one embodiment of the disclosed methods;

FIG. 5 is a flow diagram illustrating one embodiment of the disclosed methods; and

FIG. 6 is a flow diagram illustrating one embodiment of the disclosed methods.

### DETAILED DESCRIPTION OF SPECIFIC EMBODIMENTS

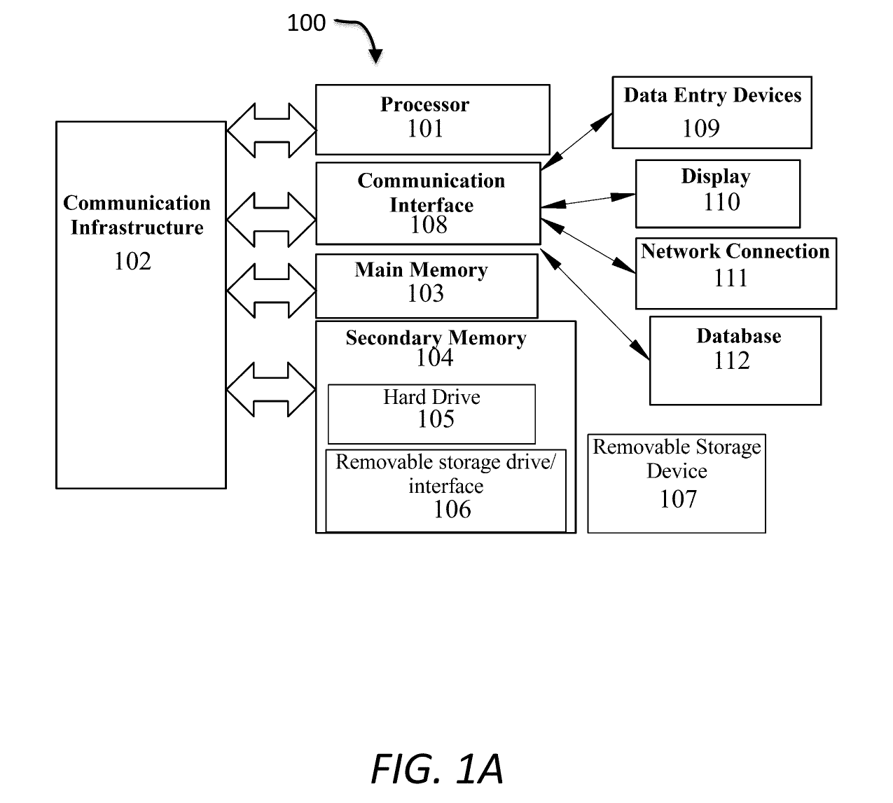

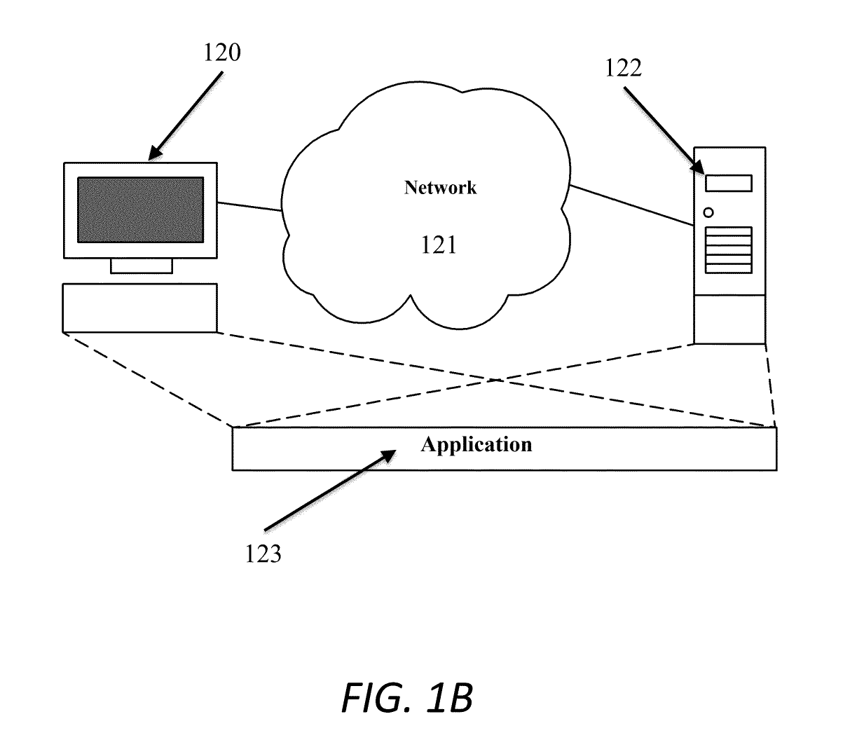

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations performed with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

Asymmetric cryptographic systems may also be used to produce and verify digital signatures. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. The network 121 can be divided into sub-networks as well, such as a network in which the computing devices making up the server 122 are nodes, or a network in which the nodes are computing devices participating in particular coordinated actions. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud. Some web applications treat the network 121 or a part thereof as a “peer-to-peer” network, which distributes computing tasks and resources among its nodes; where each computing device making up a node of the network 121 can act as a client 120 or a server 122 depending on the task the protocols of the peer-to-peer network direct it to perform.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause a computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and method store files securely by dividing the files into an unpredictable number of unpredictably sized fragments prior to storage. The fragments may be stored in a plurality of randomly selected fragment stores, and the file may be encrypted as well. Embodiments of the system and method make files thus stored far more difficult to steal.

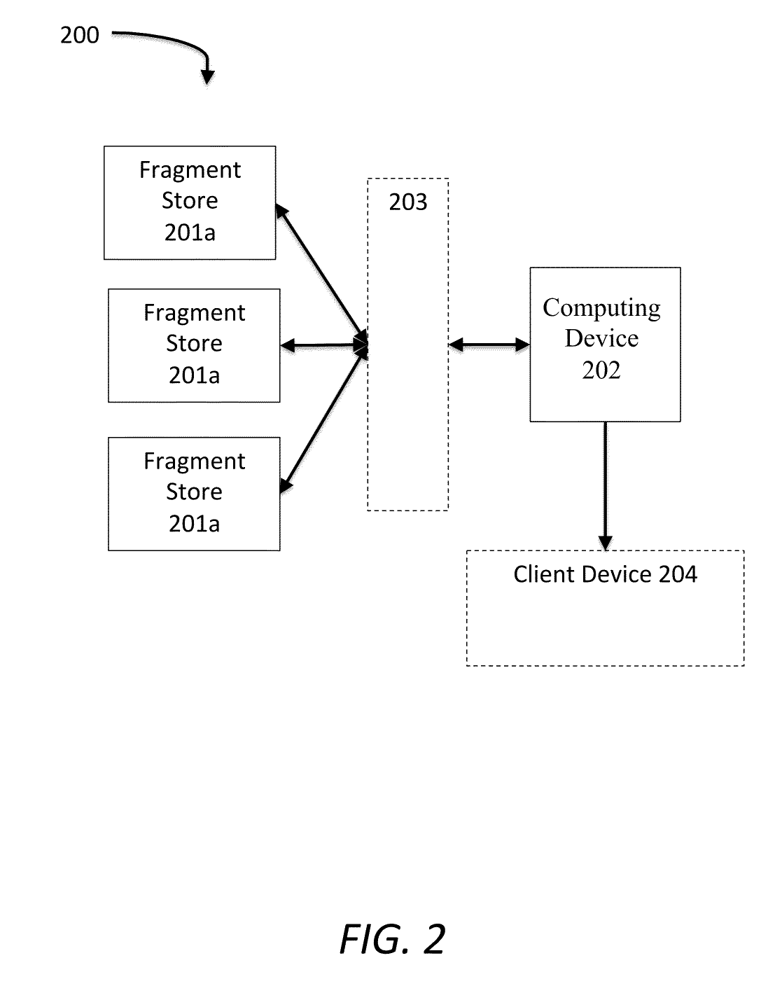

FIG. 2 illustrates an embodiment of a system 200 for securely storing and retrieving files. As an overview, the system 200 includes a plurality of fragment stores 201a-c. The system 200 further includes a computing device 202. The system 200 may include a message bus 203 or similar information-exchange intermediary.

Embodiments of the disclosed system and method involve the manipulation of electronic files. In some embodiments, electronic files, also referred to as “files,” are sets of data stored persistently in memory coupled to a computing device, such as a computing device 100 as described above in reference to FIGS. 1A-1B. In some embodiments, the data associated with a particular file are stored, retrieved, and manipulated in concert, creating an effect for the user analogous to that of retrieving and viewing a paper file. The data in a file may be stored in the form of bytes; for example, the file may be manipulated by the computing device as an array of bytes. The data in the file may be portrayed to a user by data output devices coupled to the computing device, as dictated by the formatting convention associated with the file. For instance, a file that the first computing device 201 identifies as containing an image, such as a Joint Photographic Experts Group (“JPEG”) file, may be provided to an end user as an image depicted on the display of the computing device, in which the color, brightness, and other attributes of each pixel in the image is determined by the computing device's interpretation of the data stored in the file. Likewise, data from a file identified by the computing device as containing audio data, such as a Moving Pictures Experts Group—Audio Layer III (MP3) file, may be provided to the user in the form of sound produced via by a speaker coupled to the computing device. A file may be divided, in embodiments of methods as describe below, into two or more smaller files, referred to hereinafter as fragments.

In some embodiments, the system and method make use of random numbers. In one embodiment, random numbers are numbers produced by a random number generator. A random number generator is a process or device that produces a sequence of numbers having the property that it is practically impossible, given the history of numbers produced in the sequence up to a certain point in time, to predict the subsequent number in the sequence. The random number generator may produce numbers according to a genuinely random process, such as a process that measures a random attribute of a physical system, and translates that measured output into a number. The random number generator may produce numbers according to a pseudo-random process, which produces apparently random sequences based on an initial seed value. Either numbers from genuinely random sequences or pseudo-random sequences may be random numbers as used herein.

Embodiments of the disclosed system and methods make use of data storage facilities. A data storage facility is a set of one or more physical devices in which data is electronically stored. A data storage facility may include one or more computing devices as described above in connection with FIGS. 1A-B. A data storage facility may include one or more servers as described above in reference to FIGS. 1A-B. A data storage facility may use any device for electronic storage described above in reference to FIGS. 1A-B, including databases and other data stores.

Viewing FIG. 2 in further detail, each store of the plurality of fragment stores 201a-c is a persistent electronic storage facility in which fragments of files are stored as described in further detail below. Although three fragment stores 201a-c are depicted in FIG. 2 for the purposes of illustration, there may be any number of fragment stores 201a-c. Each fragment store 201a-c may occupy computer memory 103, 104 as described above in reference to FIG. 1A. The fragment stores 201a-c may be stored on the computing device 202. The fragment stores 201a-c may be stored on one more additional devices (not shown), such as a server as described above in relation to FIGS. 1A-B. The fragment stores 201a-c may be stored on multiple computing devices; for example, one fragment store 201a may be stored on the computing device 202, while another 201b is stored on a different computing device. The fragment stores 201a-c may be distributed among computing devices according to any protocol used for distributed data storage or load balancing; as a non-limiting example, the fragment stores 201a-c may be implemented using a distributed hash table. Each fragment store 201a-c may include any data storage facility as described above in reference to FIGS. 1A-B; for instance, each fragment store 201a-c may include a database. Each fragment store 201a-c may include a key-value data storage facility; for instance, each fragment store 201a-c may include a key-value data store that uses file identifiers, as described in further detail below, as keys. Likewise, each fragment store 201a-c may store fragments in a hash table or similar data structure using file identifiers as keys. Each fragment store may have a unique identifier that is associated with that fragment store.

In some embodiments, each fragment store 201a-c is passive; that is, each fragment store 201a-c may be selected by the computing device 202 or an intermediate module such as a message bus 203, and receive a data record or query from the computing device 202 or intermediate module in the manner of an insertion call or query to a database. In other embodiments, each fragment store 201a-c has an active component; for instance, each fragment store 201a-c may have an event listener or similar component that monitors a communication module, such as the message bus 203, for the presence of fragments. The active component of each fragment store 201a-c may also have the ability to participate in a bidding process for a particular fragment detected on the message bus 203 or similar information-exchange intermediary, as described in further detail below.

The system 200 includes a first computing device 202. In some embodiments, the computing device 202 is a computing device 100 as disclosed above in reference to FIG. 1A. In other embodiments, the computing device 202 is a set of computing devices 100, as discussed above in reference to FIG. 1A, working in concert; for example, the computing device 202 may be a set of computing devices in a parallel computing arrangement. The computing device 202 may be a set of computing devices 100 coordinating their efforts over a private network, such as a local network or a virtual private network (VPN). The computing device 202 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the computing device 202 is a server 122 as disclosed above in reference to FIG. 1B. The computing device 202 may communicate with one or more additional servers 122. The computing device 202 and the one or more additional servers 122 may coordinate their processing to emulate the activity of a single server 122 as described above in reference to FIG. 1B. The computing device 202 and the one or more additional servers 122 may divide tasks up heterogeneously between devices; for instance, the computing device 202 may delegate the tasks of one component to an additional server 122. In some embodiments, the computing device 202 functions as a client device 120 as disclosed above in reference to FIG. 1B.

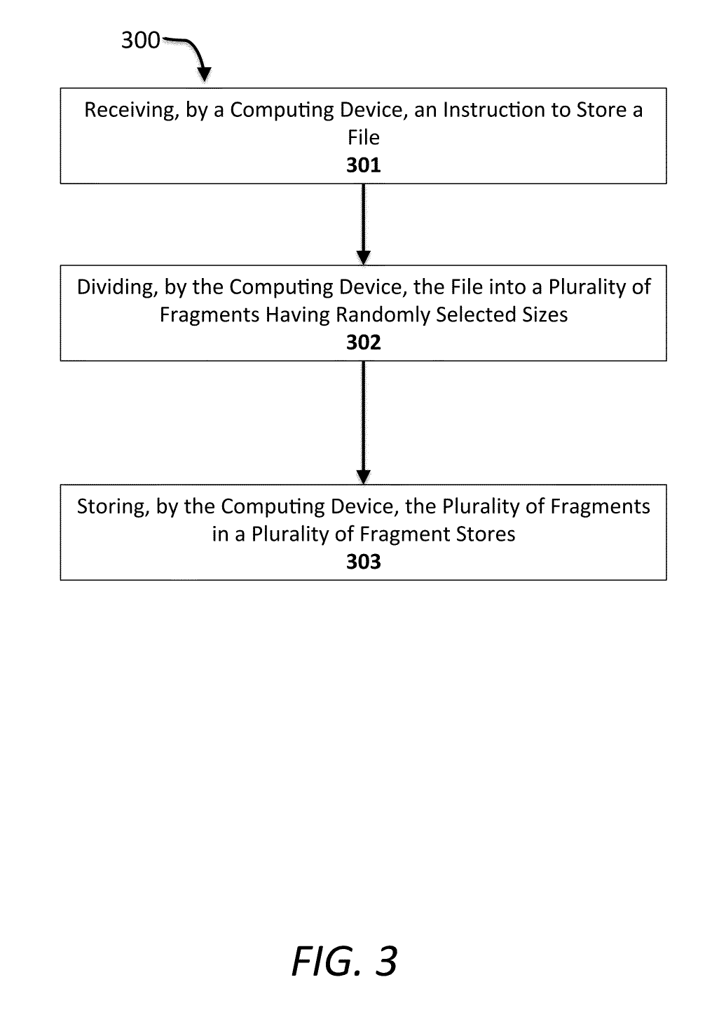

In some embodiments, the computing device 202 is configured to receive an instruction to store a file, to divide the file into a plurality of fragments having randomly selected sizes, and to store the plurality of fragments in the plurality of fragment stores, as described in further detail below in reference to FIG. 3. The computing device 202 may be further configured to divide a file into a plurality of non-empty fragments, to select randomly a first fragment store from a plurality of fragment stores, to store a first fragment of the plurality of fragments in the first fragment store, to select randomly a second fragment store from the plurality of fragment stores, and to store a second fragment of the plurality of fragments in the second fragment store. The computing device 202 may be further configured to receive an instruction to retrieve a file with an associated identifier, retrieve a plurality of fragments associated with the identifier from a plurality of fragment stores, and to assemble the plurality of fragments to produce the requested file.

In some embodiments, the computing device 202 receives instructions from a client device 204. In some embodiments, the client device 204 is a computing device 100 as disclosed above in reference to FIG. 1A. The second computing device may be any combination of computing device 100 as described above for the computing device 202, in reference to FIG. 2. The client device 204 may communicate with the computing device 202 as described above in reference to FIGS. 1A-B.

FIG. 3 illustrates some embodiments of a method 300 for securely storing a file. The method 300 includes receiving, by a computing device, an instruction to store a file (301). The method 300 includes dividing, by the computing device, the file into a plurality of fragments having randomly selected sizes (302). The method includes storing, by the computing device, the plurality of fragments in a plurality of fragment stores (303).

Referring to FIG. 3 in greater detail, and by reference to FIG. 2, the computing device 202 receives an instruction to store a file (301). In some embodiments, the instruction is entered by a user of the computing device 202. The instruction may be generated by a process running on the computing device 202; for instance, the file may be generated or updated by another application running on the computing device 202, and that other application may be programmed to store the file using this method. In other embodiments, the instruction is received from a client device 204; a user of the client device may enter the instruction, or a process running on the client device 204 may produce the instruction. Likewise, a process running on one or more additional computing devices may generate the instruction. The file may be a file that is present in memory on the computing device 202 or another linked device such as a server, and the command may be a directive to store the file more securely. The file also may be received by the computing device 202 at about the same time as the instruction; for instance, a user may upload the file by a protocol such as file transfer protocol (FTP), upon which the computing device 202 may, automatically or pursuant to an explicit instruction, proceed with the steps of this method 300 to store the file securely.

In some embodiments, the computing device 202 determines a size of the file. As an example, the computing device 202 may represent the file as a sequence of regularly sized data units, and determine the size of the file as a total number of the regularly sized data units comprising the file; for instance, the file may be represented as a sequence of bits, bytes, or the like. In some embodiments, the sequence is ordered; for instance, the file may be an array of bits or bytes having a starting point and an ending point in the memory of the computing device 202. The sequence may be stored during this process according to any memory storage convention, including as an array of contiguous memory entries of a fixed number of bits, located by the processor of the computing device 202 using numerical addresses.

The computing device 202 divides the file into a plurality of fragments having randomly selected sizes (302). The selection of randomly sized fragments may be performed using a sequence of random numbers. For instance, where the computing device 202 has determined the size of the file, the computing device 202 may generate a first random number less than the size of the file. The computing device 202 may generate the first random number by reading the output of a random number generator, comparing the output to the size of the file, and using the output if it is smaller than the size of the file; if the output is larger than the size of the file, the computing device 202 may discard the output and read another output. The computing device 202 may also scale the outputs of the random number generator to a scale less than the size of the file; for instance, the computing device 202 may use the numbers modulo a number less than the size of the file, resulting in a range of possible randomly or pseudo-randomly selected numbers having an absolute value less than the size of the file. The computing device 202 may produce a first fragment by extracting from the file a quantity of the data units of the file equal to the first random number. As a non-limiting example, where the file is stored as an array of bytes and the first random number is denoted N, the computing device 202 may create a first fragment containing the first N bytes of the file. Of course, the computing device 202 may extract the N bytes, bits, or other regularly-sized data elements, according to any other process, including selecting the final N bytes, or selecting the first or last byte of N subsections of the file. The computing device 202 may delete the N extracted data units from the file, or may otherwise act to avoid extracting those N data units a second time.

In some embodiments, the computing device 202 repeats this process at least one more time; for instance, the computing device 202 may create a second fragment from the remaining data units, which are the data units that were not used to create the first fragment. In other words, the computing device 202 may create the second fragment by generating a first random number less than the size of the file minus the first random number and producing a second fragment by extracting a quantity of remaining data units of the file equal to the second random number. The computing device 202 may repeat the process additional times; in other words, the computing device 202 may generate a plurality of random numbers having a sum less than the size of the file. The computing device 202 may extract, for each number of the plurality of random numbers, a quantity of data units that have not yet been extracted from the file equal to the number. The computing device 202 may generate the plurality of random numbers in a single step, or may generate them sequentially as described above. The extraction may also be performed in a single division step, or a sequence of steps as described above. For instance, the computing device 202 may generate the first of the plurality of random numbers, extract that number of data units, generate the second of the plurality of random numbers, extract the number of data units matching the second of the plurality of random numbers, and repeat the generation and extraction process until the process is complete. The computing device 202 may terminate the process when the file is empty; where the fragments are not deleted from the file during extraction, the computing device 202 may terminate the process when all data units have been extracted. The computing device 202 may terminate the process when the number of remaining data units, i.e. the data units that have not been extracted, is less than some threshold number. In some embodiments, the threshold number is an amount equal to the average data units per fragment extracted thus far; the computing device 202 may keep a running average, by averaging the latest extracted fragment with the previously computed average size after each extraction. The average may be calculated using any process for calculating an average, including computing an arithmetic or geometric mean. In another embodiment, the computing device 202 terminates the process when the latest random number exceeds the number of data units that have not yet been extracted. Upon termination of the process, all remaining data units may then be extracted as a final fragment.

In some embodiments, performing the process once results in a fragment and a new file constituting the original file minus the fragment; thus, embodiments of the method may thus be practiced on the new file, resulting in a repetition of the above-described steps. Where there are more than zero remaining data units, the computing device 202 may make a final fragment consisting of the remaining data units upon termination. Thus, as an illustration, a file of 1573 bytes might have 3 pieces of 904 bytes, 602 bytes and 67 bytes. Where the data units extracted were deleted from the file, the file may be empty and thus effective deleted upon the completion of the fragmenting process; in other embodiments, the computing device 202 may delete the file when the fragmenting process is complete. The computing device 202 may perform additional deletion operations, such as randomizing the memory entries that used to contain the file, to prevent recovery of the file from its memory location as used during the fragmentation process.

In some embodiments, the original document is thus divided into an unpredictable number of parts of unpredictable length, based on one or more random numbers. As such, there is no way to know how long each piece is (or should be) until the next piece is found and combined with it. This unique way of dividing a document renders it even harder for an unauthorized user or process to piece together again, as compared to a method where the size of each piece is known.

The computing device stores the plurality of fragments in a plurality of fragment stores (303). The computing device 202 may select each fragment store 201a-c according to any process used to select a storage location from among a plurality of separate storage locations in memory. In some embodiments, the selection of the fragment stores 201a-c is random. For instance, the computing device 202 may randomly select a first fragment store from a plurality of fragment stores, and store a first fragment of the plurality of fragments in the first fragment store. The computing device 202 may randomly select the first fragment store by maintaining in memory accessible to the computing device 202 a set of indices corresponding to fragment stores, generating a random number, and then mapping the random number to the set of indices to select a fragment store. In other embodiments, the computing device places the fragment in a location that fragment stores' active components monitor; the fragment stores' active components may bid for the ability to store the fragment.

In another embodiment, the computing device 202 places the fragment in the message bus 203 or in another information-exchange intermediary, and the fragment stores 201a-c bid for the fragment. As a non-limiting example, the bidding process may proceed as follows: each fragment store 201a-c may generate a random number and submit that number to the computing device 202, or message bus 203 or other information-exchange intermediary. Continuing the example, the computing device 202, or message bus 203 or other information-exchange intermediary, may then store the fragment in the fragment store 201a-c that has submitted the largest or smallest random number, or by selecting a random number that is the closest, according to some norm, to some number selected by the computing device 202, or message bus 203 or other information-exchange intermediary. The fragment stores 201a-c may also “bid” by submitting fragment store identifiers or simple requests to store the fragment, and the computing device 202, or message bus 203 or other information-exchange intermediary may choose randomly between the requests, for instance by indexing all requests, generating a random number, and choosing one or more requests by matching the request indices to the random number. In some embodiments, the computing device 202, or message bus 203 or other information-exchange intermediary, checks whether the fragment to be stored has already been stored in the selected fragment store 201a-c. In that case the computing device, or message bus 203 or other information-exchange intermediary, may instead store the fragment in an alternative fragment store; the computing device, or message bus 203 or other information-exchange intermediary, may do this by choosing the fragment store 201a-c having the second largest or smallest random number, or the second closest random number to some other number selected by the computing device, or message bus 203 or other information-exchange intermediary. Where the computing device, or message bus 203 or other information-exchange intermediary, generated a random number to select between bids, the computing device, or message bus 203 or other information-exchange intermediary, may select a new random number to select an alternative fragment store 201a-c.

In some embodiments, the computing device 202 repeats the random storage process for one or more additional fragments. For instance, the computing device may store a second fragment by randomly selecting a second fragment store from the plurality of fragment stores and storing a second fragment of the plurality of fragments in the second fragment store. The computing device 202 may perform the random selection of the second fragment store as described above for the selection of the first fragment store. The computing device 202 may repeat the process for each fragment of the plurality of fragments. In some embodiments, the computing device 202 repeats the process one or more times for the same fragment. For instance, the computing device 202 may maintain a counter that represents the number of copies of the first fragment to be stored, and decrement the counter each time a copy of the first fragment is stored in a fragment store. The computing device 202 may repeat the process until the counter reaches zero, indicating that the desired number of copies of the fragment have been stored.

In some embodiments, storing the plurality of fragments further involves storing a first fragment of the plurality of fragments in a fragment store in a first data storage facility and a second fragment of the plurality of fragments in a second data storage facility. The second data storage facility may be distinct from the first data storage facility, where two data storage facilities are distinct if they do not have any computing device or data storage device in common. In some embodiments, the first data store uses a first security protocol and the second data store uses a second security protocol. The first security protocol may use at least one security technique that is not used by the second security protocol. As a non-limiting example, an entity that owns the file may choose to keep fragments making up approximately 2% of the data units comprising the file in data storage under the direct control of the entity, while storing the remaining approximately ninety-eight percent of the data in a cloud storage facility operated by a different entity. Continuing the non-limiting example, as a result, the entity may gain a cost advantage attendant to cloud storage for 98% of the entity's storage needs, while also being confident that it is impossible for a hacker to steal any file in totality unless they also hack into the entity's firewall and steal the 2% that the entity retains.

In some embodiments, this is made possible by the fact that each ‘fragment store’ can live independently of the others, and may be remote from the others in terms of physical geography and/or network topology, as noted above. Thus, for instance, if there are 15 fragment stores, 14 may be in various cloud locations and 1 may be behind the firewall of a given company; as a result, in one embodiment no file can ever be completely reconstituted without reaching behind the company's firewall to get the relatively small number of pieces resident there.

In some embodiments, the computing device 202 generates a unique file identifier associated with the file. In some embodiments, the identifier is unique if no other file stored in the system 200 has the same identifier. The computing device 202 may generate the unique identifier by any suitable process, including according to globally unique identifier (GUID) or universally unique identifier (UUID) processes. The computing device 202 may generate the unique identifier by generating a random number and comparing the random number to each file identifier already in use; the computing device 202 may maintain the collection of file identifiers in a data structure such as an array, tree, or linked list in which the computing device can rapidly look up existing file identifiers and compare them to the random number. The computing device may associate the file identifier with each of the plurality of fragments. In some embodiments, the file identifier is associated with a fragment if the file identifier and fragment are stored together wherever the fragment is stored in memory. For example, the computing device 202 may associate the file identifier with the fragment by appending it to the fragment. The computing device 202 may associate the file identifier with the fragment by storing the fragment and identifier together in a data structure. The computing device 202 may associate the file identifier with the fragment by sending the fragment and identifier together in a record such as a network packet, extensible markup language (xml) file, or similar record. The computing device 202 may associate the file identifier with the fragment by sending both as arguments to a function call or command. The identifier may be with the fragment in each fragment store 201a-b, so that querying the fragments for that file identifier, as described in further detail below, will cause the fragment store 201a-b to find and return any fragments from the file associated with the file identifier; for instance, where the fragment store includes some key-value data storage facility, such as a hash table or NoSQL data store, file identifiers may be used as keys, while fragments are stored as values. In some embodiments, identifiers or identifying information used to identify the file to users, other computing devices, or other processes or modules are not the file identifier; for example, the computing device may link a particular file name to the file identifier in a table or other data structure that is kept invisible to devices, processes, and modules exterior to the system 200.

The computing device 202 may generate a fragment identifier for each fragment. That is, the computing device 202 may generate a plurality of fragment identifiers, each of the plurality of fragment identifiers corresponding to one and only one fragment of the plurality of fragments, and associate each fragment identifier of the plurality with the corresponding fragment of the plurality of fragments. In some embodiments, the computing device associates each fragment identifier with its corresponding fragment in any manner suitable for associating the file identifier with a fragment. In some embodiments, the fragment identifier is unique to its corresponding fragment if the fragment identifier differs from all of the other fragment identifiers for fragments derived from the file; in other words, the fragment identifier may be unique if it is also the same as the fragment identifier for a fragment of a different file. In some embodiments, the fragment identifier is a sequence number indicating the position of the fragment in the file, or indicating when in the extraction process the fragment was extracted; for instance, a sequence number of 3 might indicate that the fragment was the third fragment extracted from the file, or that the fragment is the third fragment from the front of the file.

In some embodiments, the computing device 202 encrypts the file. The computing device 202 may encrypt the file prior to dividing the file into fragments; in other words, the file the computing device 202 divides into fragments may be the encrypted or cyphertext version of the file. Where the file is encrypted prior to division into fragments, the computing device 202 may determine the size of the file, as described above, after encryption; the size of the encrypted file may differ from the size of the plaintext version of the file in some embodiments, depending on the encoding scheme used in the file and the form of encryption employed. The computing device 202 may use any cryptographic system to encrypt the file; in some embodiments, the computing device 202 uses a symmetric encrypting system. For instance, the computing device 202 may use a version of AES, such as 256-bit AES, to encrypt the file. The computing device 202 may also encrypt the file after division into fragments; that is, the computing device 202 may encrypt each fragment. The computing device 202 may use the same key for each fragment, or the computing device may encrypt the fragment or fragments separately, as set forth in further detail below. The encryption and decryption key or keys may be stored by the computing device 202 separately from the file fragments; for instance, the computing device 202 may maintain a database or other data structure matching encryption and decryption keys to the file numbers of the files those keys are used to decrypt or encrypt.

The computing device 202 retrieves the file upon receiving a request to retrieve the file. In some embodiments, the computing device 202 receives a request for the file. The computing device 202 may receive the request according to any manner described above for receiving the request to store the file. The request may identify the file according to something other than the file identifier; for instance, the request may specify a file name, or a file name combined with a user or process identifier. The computing device 202 may use the information from the request to look up the file identifier in a table or other data structure matching information identifying the file to the file identifier.

The computing device 202 may retrieve the plurality of fragments from the plurality of fragment stores. In some embodiments, the computing device 202 queries the fragment stores for the file identifier; the computing device 202 may send a message to the message bus 203 containing the file identifier and requesting fragments matching the file identifier. Each fragment store 201a-b may send all fragments matching the file identifier to the computing device 202 in response to the query; where the fragment stores 201a-b have listeners monitoring the message bus 203, the fragment stores 201a-b may retrieve the request from the message bus 203 and post a response to the message bus 203 containing all fragments associated with the file identifier.

The computing device 202 may assemble the plurality of fragments to produce the file. The computing device 202 may discard duplicate fragments; in some embodiments, the computing device 202 determines that a first fragment of the plurality of retrieved fragments is a duplicate of a second fragment of the plurality of retrieved fragments and discards the first fragment. The computing device 202 may determine that the first fragment is a duplicate of the second fragment by comparing the fragments directly; alternatively, where the fragments have fragment identifiers, the computing device 202 may determine that the first fragment has the same fragment identifier as the second fragment. In some embodiments, the computing device determines that the complete set of fragments has been retrieved because the cumulative size of retrieved fragments equals the size of the file. In some embodiments, where each fragment of the plurality of fragments is associated with a fragment identifier, the computing device 202 assembles the fragments by determining an order of assembly based on fragment identifiers and assembling the fragments in the determined order of assembly. For instance, where the fragment identifiers are sequence numbers that indicated the order of the fragments in the file, the computing device 202 may use the sequence numbers to arrange the fragments in the memory in the order indicated by the fragment identifiers; for instance, the fragment identifier of a first fragment may indicate that the first fragment should be located at the beginning of a sequence of bytes comprising the file, while the fragment identifier of a second fragment may indicate that the second fragment should be located immediately after the first fragment, or separated from it by one or additional fragments. Alternatively, the sequence numbers may indicate the order in which the fragments were extracted from the file and the computing device 202 may reassemble the file by assembling the fragments in the order in which they were extracted, or in the reverse of that order.

In other embodiments, the computing device 202 records elsewhere in memory the order in which the fragments were extracted, or the order of the fragments in the file, and looks up each fragment's place in that order using the fragment identifier.

In some embodiments, where the file was encrypted as described above, the computing device 202 decrypts the file. The computing device 202 may look up the decryption key or decryption keys where the computing device 202 stored the keys. Where the computing device 202 encrypted the file prior to division into fragments, the computing device 202 may decrypt the file after assembling the fragments. Where the computing device encrypted the file 202 after division of the file into fragments, the computing device 202 may decrypt the fragments prior to assembling them into the file.

In embodiments of the above-described method, there is no such thing as a ‘file at rest’, whether encrypted or not; in some embodiments, in order to illegally obtain files, a hacker would have to (a) steal the decryption key, (b) steal the file size which is somewhere else, (c) steal all the fragments from all the fragment stores, (d) put the whole file back together, and (e) repeat the whole process for each desired file. As a result, the theft of the file may be exceedingly difficult.

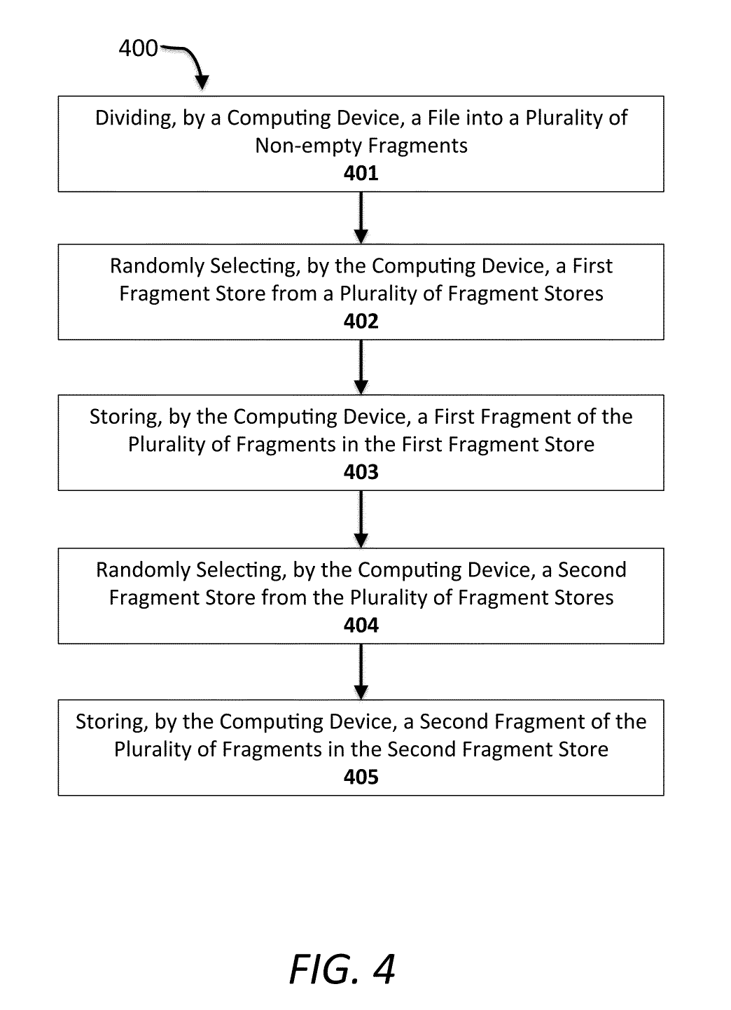

FIG. 4 illustrates some embodiments of a method 400 for securely storing a file. The method 400 includes dividing, by a computing device, a file into a plurality of non-empty fragments (401). The method 400 includes randomly selecting, by the computing device, a first fragment store from a plurality of fragment stores (402). The method 400 includes storing, by the computing device, a first fragment of the plurality of fragments in the first fragment store (403). The method 400 includes randomly selecting, by the computing device, a second fragment store from the plurality of fragment stores (404). The method 400 includes storing, by the computing device, a second fragment of the plurality of fragments in the second fragment store (405).

Referring to FIG. 4 in greater detail, and by reference to FIG. 2, the method 400 includes dividing, by a computing device, a file into a plurality of non-empty fragments (401). In some embodiments, the plurality of non-empty fragments is randomly selected as described above in reference to FIG. 3. In other embodiments, the plurality of non-empty fragments is not randomly selected; for instance, the computing device 202 may divide the file into regularly sized fragments, or into irregularly sized fragments according to a non-random pattern. The fragments may be associated with a file identifier as described above in connection with FIG. 3. The fragments may be associated with fragment identifiers as described above in connection with FIG. 3. The computing device 202 may encrypt the file either before or after division into fragments, as described above in reference to FIG. 3.

The method 400 includes randomly selecting, by the computing device, a first fragment store from a plurality of fragment stores (402). This may be implemented as described above in connection with FIG. 3 regarding the random selection of a fragment store.

The method 400 includes storing, by the computing device, a first fragment of the plurality of fragments in the first fragment store (403). This may be implemented as described above in connection with FIG. 3.

The method 400 includes randomly selecting, by the computing device, a second fragment store from the plurality of fragment stores (404). This may be implemented as described above in connection with FIG. 3 regarding the random selection of a fragment store.

The method 400 includes storing, by the computing device, a second fragment of the plurality of fragments in the second fragment store (405). This may be implemented as described above in connection with FIG. 3. The computing device may also retrieve the file, as described above in reference to FIG. 3. In some embodiments, the method 400 includes selecting, for each of the remaining fragments of the plurality of fragments, a randomly selected fragment store, and storing that fragment the randomly selected fragment store; the random selection and storage process may be repeated until there are no more fragments to store.

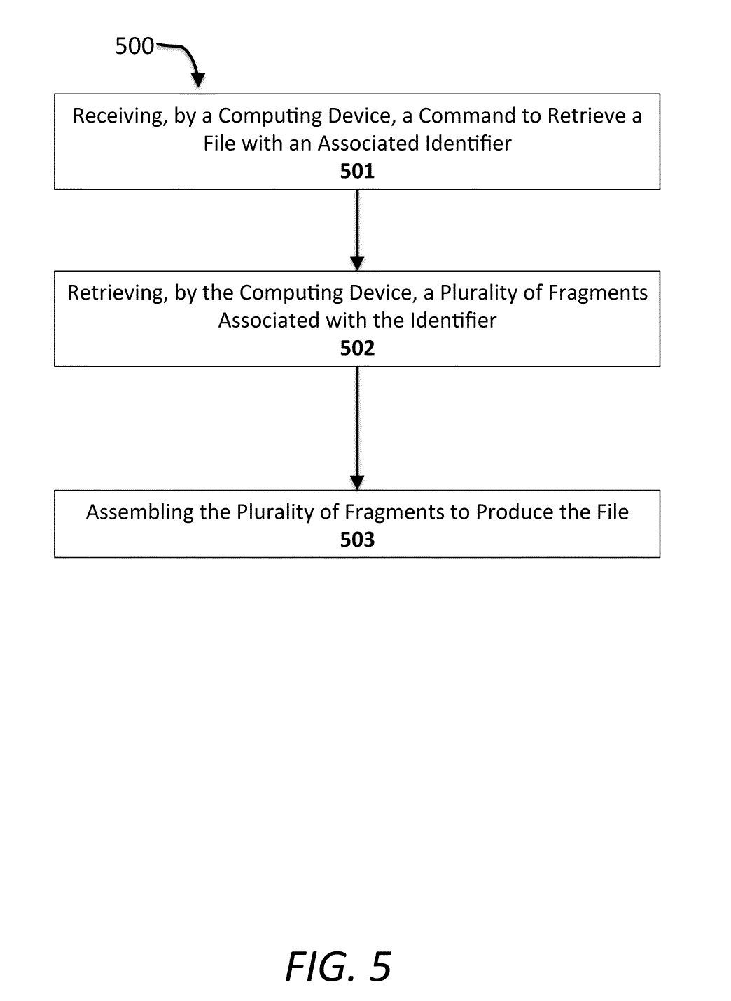

FIG. 5 illustrates some embodiments of a method 500 for retrieving a securely stored file. The method 500 includes receiving, by a computing device, an instruction to retrieve a file with an associated identifier (501). The method 500 includes retrieving, by the computing device, a plurality of fragments linked to the identifier from a plurality of fragment stores (502). The method 500 includes assembling the plurality of fragments to produce the file (503).

Referring to FIG. 5 in greater detail, and by reference to FIG. 2, the method 500 includes receiving, by a computing device, an instruction to retrieve a file with an associated identifier (501). This may be performed as described above in reference to FIG. 3.

The method 500 includes retrieving, by the computing device, a plurality of fragments associated with the identifier from a plurality of fragment stores (502). This may be implemented as described above in reference to FIG. 3. In some embodiments, the file has been stored in a plurality of fragment stores as described in reference to FIG. 3. In other embodiments, the file has been stored in a plurality of fragment stores as described above in reference to FIG. 4.

The method 500 includes assembling the plurality of fragments to produce the file (503). This may be performed as described above in reference to FIG. 3.

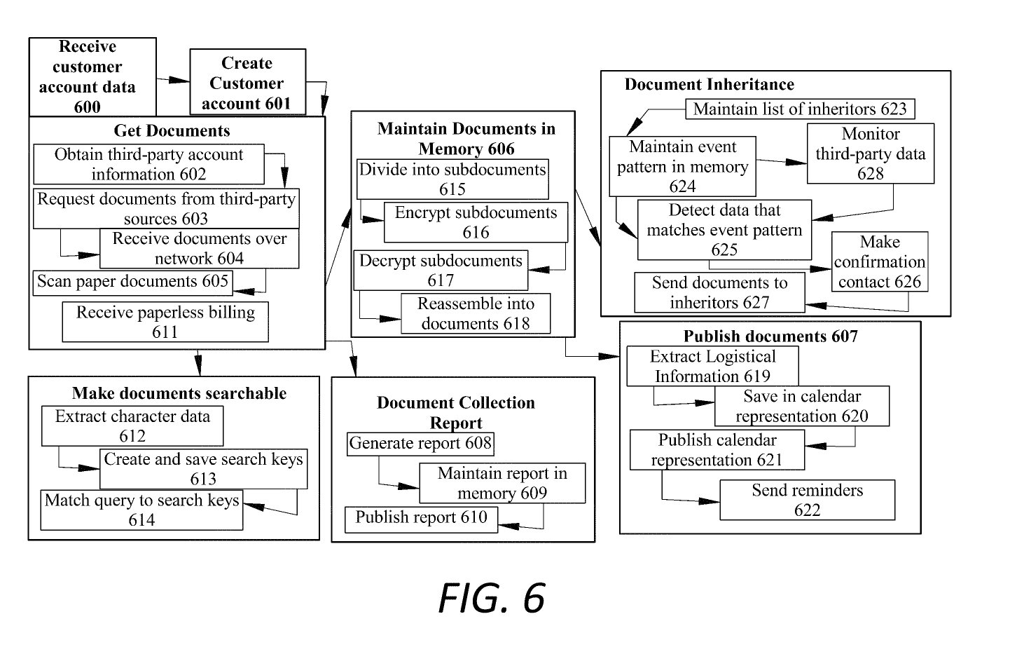

FIG. 6 illustrates additional method embodiments the system 200 may perform for storing and retrieving personal documents. In some embodiments, upon receiving customer data 600, the computing device 202 creates a customer account 601. This process may be initiated by the customer, but a third party, such as a bank or other institution involved with the customer, may create the account 601 on the customer's behalf, with the customer's permission. The administrator of the system 200 may also create partnership programs with institutions that tend to generate customer documents; the institutions may maintain files for their customers that contain documents in the custody of the institutions, and offer the customers the option of creating a more general repository with the institutions' documents as a nucleus. The creation of the customer account 601 may also include the establishment of a security system by means of which only the customer, and persons the customer authorizes, may gain access to any of the customer's account information or documents.

Once the customer account exists, the computing device 202 may proceed to collect the customer's personal documents. In some embodiments, this is ultimately a customer-directed process: the personal documents may include virtually any document the customer wishes to have at his or her disposal in electronic form, including without limitation contracts, deeds, wills, bills, trusts, medical records, and anything else of a legal, financial, or personal nature the customer chooses, within the bounds of applicable law. In some embodiments, the computing device 202 acquires these documents in several ways. First, the computing device 202 may have the documents sent in electronic form 604 via the network. Protocols for sending documents over networks are well-known to persons skilled in the art; among other options, documents may be sent via File Transfer Protocol (FTP) or via electronic mail. The customer may send any electronically stored documents in the customer's possession over the network. The customer may also give the system 200 third-party account information 602 necessary to access the customer's accounts on other devices connected to the network, such as devices under control of another party with whom the customer has an account, from which the system may request electronic transmission of customer documents 603. Customers may also set up regular forwarding from their own email accounts to the system 200, so that their emails are all captured as documents, along with attachments. Whatever the origin of the electronically transmitted documents, the system may record each document's source. In one embodiment, if one customer wants to send a document to another customer within the system 200, the exchange of documents is a matter of copying or even adding a link to the same document copy, and keeping track of document origin is matter of transaction history. The customer or the entity managing the system 200 may also directly contact such providers by other means, such as telephone, electronic mail, or regular mail, to request that the documents be transmitted. The system 200 may also receive documents in paper form, and scan them to create digital images 605, which may be converted to electronic documents by the system. Scanners and other optical data entry means capable of capturing such digital images are well known to persons of ordinary skill in the art. As before, customer may send the paper documents directly, or request that another entity send them.

Once the system 200 receives the documents, it may maintain them in its memory 606. This may involve storing the documents in a directory on the computing device 202, or in a database, or in any form of computer-readable storage coupled to the computing device 202. In some embodiment, maintaining the documents implies not only storing them in and retrieving them from memory as needed, but also updating them, deleting them if necessary, and organizing them to aid in easy retrieval and viewing. The customer may be able to exercise some control over the way in which document storage is organized, so that the customer can sort through and find the documents easily. The customer may also be permitted to delete the documents when he or she chooses. In some embodiments, the documents are published 607 as directed by the customer. The customer may typically be able to see any document on the system, so the document chosen by the customer may be shown to him or her in full by transmitting image data to the customer's current client machine, or allowing the customer to download a copy of any document. Publication 607 may also involve presenting titles, nicknames, excerpts, or summaries of documents for the customer's perusal, to aid the customer in locating documents he or she wishes to view in full. Documents or any data from them may be published 607 to other persons or entities as directed by the customer. For instance, the customer may grant certain health care professionals the right to view certain medical documents, or may allow an attorney to view documents pertinent to the attorney's representation of the customer.

In some embodiments, some of the document collection steps FIG. 6 described above, such as requesting third-party sites to send their documents 603, are not certain to succeed in every case, despite the best efforts of all parties. Many websites, with good reason, have security features designed to repel automated systems from accessing them; in some cases, laws and regulations might require some human interaction prior to the transfer of documents. For that reason, some embodiments of the method include the generation of a report detailing the success or failure of the document collection process 608. The report may be generated 608 during the collection procedure, or afterwards when the procedure has concluded, using data collected during the procedure. For example, when the system attempts to log onto the customer's bank account and download checking, savings, and credit card statements, if a security feature in the bank system denies the system access, that denial, and the reasons for it, may be recorded in the system's memory, and used to generate the report 608. Each such report may be maintained in the system's memory 609 for future reference, and the report is published 610 to the client in some form or other. In some embodiments, this helps the client follow up in collecting important documents that could otherwise fall through the cracks.

Paperless billing is an increasingly common phenomenon in the world of commerce. Paperless billing replaces bills, notices, and other documents traditionally sent by institutions via the postal service with digital versions of the same bills, notices, or documents. The digital versions are generally published by electronic mail, although other transfer protocols could be used. To save the customer the trouble of forwarding paperless billing, the system may set up a paperless billing account 611 with the institutions themselves. The system may publish 607 the paperless billing documents to the customer as soon as they arrive.

In some embodiments, the computing device 202 allows users or other processes or modules to search the documents 614. In other words, a customer may be able to enter a query, and the computing device 202 may be able to retrieve documents matching the query 614. In some embodiments, the computing device 202 retrieves the documents as described above in reference to FIG. 3. The computing device 202 may extract character data from the documents 612, and turn that character data into search keys 613. A search key is any item of data that can be used to identify a particular document; it may represent information from the document that a customer is likely to search for. There may be many search keys per document. The system may match the query entered by the customer to search keys 614 to locate a document for retrieval.

In addition to the various techniques for preventing breaches known to persons skilled in the art, and to the techniques described above in reference to FIGS. 2-5, some embodiments of the method include an algorithm to minimize the damage resultant from such breaches. In some embodiments, when each document is stored in the system memory, 606, the computing device 202 divides it into sections 615 or subdocuments. This division may involve separating the document into different blocks of text and images which would each be recognizable as part of a document. In other embodiments, the division is done in such a way that each subdocument is not itself intelligible; for instance, if the document is initially stored as a long array of bits in the underlying electronic device, one subdocument may consist of every third bit from that array. Any approach may be used as long as the subdocuments may be reassembled to create the document again. In some embodiments, after division, the system encrypts each subdocument separately 616 using a robust cryptosystem. Separate encryption in this section refers to using a different encryption key for each subdocument. When the customer or other authorized person wishes to read or download a document, the various encrypted subdocuments may be decrypted 617 and reassembled 618 prior to publication of the document 607. In some embodiments, any entity that attempts to steal documents by raiding the system memory through other channels will end up with many different encrypted files, each of which when decrypted is itself useless as a source of information. Even if the hacker in question has managed to download all of the subdocuments for any one of the documents on the system, the process of breaking the encryption on every file and then attempting to join them into intelligible documents may be made so onerous as to be prohibitive.

In addition to providing customers with a place where they can reliably store their personal documents, some embodiments of the disclosed method also help customers keep current with their obligations as set forth in those documents by means of an automatically generated calendar feature 620. For the purposes of this document, a “calendar” is a digitally stored data file or data structure whose elements represent events occurring in the past or future, and which can be published to a user of the system in such a way as to indicate when each event is occurring in time. In some embodiments, the system creates the calendar by parsing the documents for logistical information 619. Logistical information is information concerning events that have to occur on particular dates, events that have to occur after a certain amount of time has elapsed, or any other information that places events or transactions described in the document in question at a particular place or time. A simple implementation may search for dates and times, and adjacent character data and save them in a data type that pairs dates with associated data. More complicated implementations may look for patterns that match time periods (e.g., numbers associated with character strings that indicate a unit of time, such as “years” or “days”). That time period may be linked with dates provided elsewhere on the document to produce an elapsed time period. One useful example of a document with logistical information is a bill: the logistical data is the payment due date, the amount of the payment due, and where and how the payment may be made. In some embodiments, the logistical data thus collected is then saved in a calendar 620, which is any data type saved to the memory of the system that lists those pairs of dates with the associated event descriptions. The calendar may be published 621 to client devices as authorized by the customer. The customer may have the ability to compare the entries in the calendar to the documents with which they originated and to edit the entries as necessary to correct errors in the process, to render the entries in a form more readily recognizable to the customer, or to update information based on more recent events.

In some embodiments of the method, the system 200 uses the calendar to send reminder messages to the customer 622. These reminders may be transmitted by electronic mail, automatic phone calls, short message service messages to a mobile phone, or other manner of electronic transmittal. The messages may also be designed to pop up when the customer logs onto his or her account to view documents. The lead-time for the message is another implementation decision; it may default to a certain period in days, weeks or hours. The customer may also choose what lead time reminders should provide, or choose not to have reminders at all under some circumstances.

Some embodiments of the claimed method FIG. 6 are calculated to solve the problem of document inheritance. To do so, the system 200 may maintain a list of document inheritors 623. This list in its simplest form may contain nothing more than a list of persons designated by the customer to inherit all documents maintained on the system for the customer's benefit. The list may also include which documents or categories of documents to release to each person. In addition to accepting customer designations for the list, the system may also read the documents as before to extract the names of persons who should be inheritors. For instance, for a life insurance policy, the names of persons listed as beneficiaries on the policy documents may be put on the list and associated with the policy documents. The customer may then supply contact information and other details as needed, or add or remove inheritors. Also maintained in the system memory may be a set of event patterns 624 corresponding to an event after which the inheritors may receive the documents. Upon the occurrence of data matching the event pattern 625, the system may send a confirmation message to the customer or to somebody else 626 to make sure the event has in fact occurred. Continuing the example of life insurance, one event that affects the beneficiaries' rights is the death of the insured. The event pattern 625 in that case may be a lack of contact from the customer for some period of time, suggesting, among other things, that the customer has died. However, there could be other explanations for the cessation of contact. The customer could be hospitalized or comatose, for example, or may have been incarcerated. Thus, the system may send an email 626 to one or more persons designated as contact persons, asking whether the customer is dead, and requiring an affirmative answer to confirm the event. Alternatively, the system may attempt to contact the customer directly 626, interpreting a failure to respond as confirmation. Whatever the implementation of the method fixes as confirming the event, when it is confirmed, the documents may be sent to the inheritors 627. Thus, for instance, if the insured in a life insurance policy has died, and this has been confirmed 626 by the next of kin, then the system may look up the beneficiaries on the inheritor list 623, and send the policy documents to them, so they know what they need to do to collect on the policy. The list may also contain the inheritors' preferred means of contact and the information necessary to contact them by that means, such as their address, electronic mail address, phone number, or other information.

In addition to passively accepting data such as the passage of time or the arrival of a certain kind of document or message, under some embodiments of the method the system also monitors data on third-party sites to check for data matching the event pattern 628. For instance, if the event the system seeks to detect is the customer's death, the system may periodically check 628 the Social-Security Administration death master file. A listing of the customer's death on that file may be interpreted as matching the profile of a death event, triggering an attempt to contact another person or entity to confirm that death has occurred.

Although the foregoing systems and methods have been described in some detail for purposes of clarity of understanding, it will be apparent that certain changes and modifications may be practiced within the scope of the appended claims.

What is claimed is:

1. A method for securely storing a file, the method comprising:
receiving, by a computing device, an instruction to store a file;
dividing, by the computing device, the file into a plurality of fragments having randomly selected sizes; and
storing, by the computing device, the plurality of fragments in a plurality of fragment stores.

2. The method of claim 1 further comprising:
representing the file as a sequence of regularly sized data units; and
determining a size of the file equal to a total number of the regularly sized data units comprising the file.

3. The method of claim 2, wherein dividing further comprises:
generating a first random number less than the size of the file; and
producing a first fragment by extracting from the file a quantity of the data units of the file equal to the first random number.

4. The method of claim 3 further comprising:
generating a second random number less than the size of the file minus the first random number; and
producing a second fragment by extracting a quantity of remaining data units of the file equal to the second random number.

5. The method of claim 2 further comprising:
generating a plurality of random numbers having a sum less than the size of the file; and
for each number of the plurality of random numbers, extracting from the data units that have not yet been extracted from the file a quantity equal to the number.

6. The method of claim 1, wherein storing further comprises:
randomly selecting, by the computing device, a first fragment store from a plurality of fragment stores; and
storing, by the computing device, a first fragment of the plurality of fragments in the first fragment store.

7. The method of claim 6 further comprising:
randomly selecting, by the computing device, a second fragment store from the plurality of fragment stores; and
storing, by the computing device, a second fragment of the plurality of fragments in the second fragment store.

8. The method of claim 1 where storing further comprises storing a first fragment of the plurality of fragments in a fragment store in a first data storage facility and a second fragment of the plurality of fragments in a second data storage facility, wherein the second data storage facility is distinct from the first data storage facility.

9. The method of claim 1 further comprising:
generating a unique file identifier associated with the file; and
associating the file identifier with each of the plurality of fragments.

10. The method of claim 1 further comprising:
generating a plurality of fragment identifiers, each of the plurality of fragment identifiers corresponding to one and only one fragment of the plurality of fragments; and
associating each fragment identifier of the plurality with the corresponding fragment of the plurality of fragments.

11. The method of claim 1 further comprising encrypting the file.

12. The method of claim 1 further comprising:
receiving, by the computing device, a request for the file;
retrieving, by the computing device, the plurality of fragments from the plurality of fragment stores; and
assembling the plurality of fragments to produce the file.

13. The method of claim 12, wherein each fragment of the plurality of fragments is associated with a file identifier corresponding to the file, and retrieving further comprises retrieving a plurality of fragments associated with the file identifier.

14. The method of claim 12, wherein each fragment of the plurality of fragments is associated with a fragment identifier, and assembling further comprises determining an order of assembly based on fragment identifiers and assembling the fragments in the determined order of assembly.

15. The method of claim 12 further comprising:
representing the file as an ordered sequence of regularly sized data units;
determining a size of the file equal to a total number of the regularly sized data units comprising the file;
determining that the plurality of retrieved fragments contains a number of data units equal to the size of the file; and
determining that fragments representing the entire file have been retrieved.

16. The method of claim 12 further comprising decrypting the file.

17. A system for securely storing files, the system comprising:
a plurality of fragment stores; and
a computing device configured to receive an instruction to store a file, divide the file into a plurality of fragments having randomly selected sizes, and to store the plurality of fragments in the plurality of fragment stores.
